(19) United States
(12) Patent Application Publication
(10) Pub. No.: US 2026/0243957 A1
(43) Pub. Date: Aug. 20, 2026

(54) A BROADBAND PHOTONIC COUPLER

(71) Applicant: Agency for Science, Technology and Research, Singapore (SG)

(72) Inventor: Landobasa Yosef Mario Alexander Lumban Tobing, Singapore (SG)

(21) Appl. No.: 19/162,236

(22) PCT Filed: Feb. 15, 2024
(86) PCT No.: PCT/SG2024/050079

§ 371 Date: Sep. 4, 2025

(30) Foreign Application Priority Data
Mar. 14, 2023 (SG) 10202300694P

(51) Int. Cl. G02B 6/122

(52) U.S. Cl. CPC G02B 6/1228

(57) ABSTRACT

This document describes a photonic coupler having broadband and phase-corrected capabilities with low-power requirements.

### RELATED APPLICATION

This application claims the benefit of priority to Singapore patent application Ser. No. 10202300694P filed 14 Mar. 2023, the contents of which are hereby incorporated by reference in their entirety for all purposes.

### TECHNICAL FIELD

This application relates to a photonic coupler having broadband and phase-corrected capabilities with low-power requirements.

### BACKGROUND

Optical interconnects remain among the most recognized and the most effective approach for fulfilling the burgeoning high bandwidth data density requirements required by contemporary data centers, long-distance communication networks, and pcta/cxa-scale high-performance computers. Consequently, there is an escalating demand for cost-efficient Coarse Wavelength Division Multiplexing (CWDM) components that are characterized by a wideband response as such components facilitate the processing of multiple wavelength channels with minimal insertion loss and crosstalk (or a high extinction ratio). In addition to the requirements above, these CWDM devices must also be resilient to temperature fluctuations, particularly up to 80° C., and should be able to maintain their performance levels without the need for active tuning or post-manufacturing adjustments. To this end, Silicon Photonics (SiPh), which leverages the mature and economical silicon complementary metal-oxide-semiconductor (CMOS) technology, emerges as an optimal platform for the wafer-scale fabrication of photonic integrated circuits (PICs). Silicon Photonic material systems that are noted for their high refractive index contrasts, such as silicon-on-insulator (SOI) and silicon nitride (SiN), enable the compact integration of photonic devices on a single chip. Notably, PICs manufactured from SiN exhibits enhanced temperature stability and reduced dispersion in comparison to PICS manufactured from SOI.

As CWDM devices operate based on the principle of interference of light from different waveguides of specific pathlengths (which are combined/split by optical couplers) it is therefore evident that CWDM devices are very sensitive to the phase responses of its constituent components. This sensitivity is especially pronounced in CWDM lattice filters, which incorporate multiple cascades of Mach-Zehnder Interferometers which comprise of meticulously engineered coupling ratios. Deviations in phase responses in any of these CWDM components can lead to spectral distortions, necessitating the need for active tuning for phase correction to uphold the device's performance. However, this continuous phase adjustment causes the device's power consumption to escalate, rendering it a less cost-effective solution for the widespread deployment of CWDM devices in data centers. This translates to a need for all-passive, cost-efficient CWDM devices that negate the need for active tuning, and this may be achieved through the use of components that have a broadband bandwidth and inherent phase correction abilities.

Attempts to address the challenges for cost-effective, low-power, broadband, and phase-corrected CWDM devices have been nontrivial. This is mainly attributed to the wavelength dependence (or dispersive effect) of an optical waveguide and the interferometric character of CWDM components, such as that of the optical coupler. While specific material systems with low dispersion coefficients, such as silicon nitride (SiN), may be employed to minimize waveguide dispersions, the dispersion that occurs is still much smaller than the inherent dispersive effects originating from the optical coupler. The two factors that determine the amount of optical coupling that occurs between two waveguides are the mode index differences and spatial mode overlap between the two guided modes in the waveguides.

As known in the art, efficient coupling occurs when the two guided modes propagate at the same phase velocity (or in phase-matched condition), at which the optical signals can fully couple from one waveguide to another. However, this condition is heavily affected by the spatial mode overlap between the two guided modes as the amount of overlap increases at longer wavelengths due to the weaker confinement of the modes in the waveguides. This leads to the known coupling dispersion effect of phase-matched coupled waveguides, whereby the coupling ratio increases as the length of the wavelength increases. However, when such components are incorporated into CWDM devices, the phase-matched coupler gives rise to a non-uniform spectral response in the performance of the device.

Despite the efforts of those skilled in the art, current techniques are still unable to take into consideration the phase distortions that accompany the broadband coupling spectrum of a broadband photonic coupler.

### SUMMARY

In one aspect, the present application discloses a broadband photonic coupler comprising a directional coupler and a phase compensator. The directional coupler comprises a first waveguide having a first coupling section, an input section comprising an input segment and an input tapered segment that extends away from the input segment towards an end of the first coupling section, and an output section, and a second waveguide having a second coupling section, an input section comprising an input segment and an input tapered segment that extends away from the input segment towards an end of the second coupling section, and having an output section. The first and second coupling sections have dissimilar widths, and a coupling region of the directional coupler is defined by the first and second coupling sections. As for the phase compensator, it comprises a third waveguide having a first phase compensation section, an input section comprising an input segment and an input tapered segment that extends away from the input segment towards an end of the first phase compensation section, and an output section, whereby an end of the input segment of the third waveguide is connected to an end of the output section of the first waveguide, and a fourth waveguide having a second phase compensation section, an input section comprising an input segment and an input tapered segment that extends away from the input segment towards an end of the second phase compensation section, and an output section, whereby an end of the input segment of the fourth waveguide is connected to an end of the output section of the second waveguide. The input segments of the first, second, third and fourth waveguides have similar widths, a width of the first phase compensation section is similar to the width of the second coupling section, and a width of a second phase compensation section is similar to the width of the first coupling section, and a gap spacing between the first and second coupling sections is different from a gap spacing between the first and second phase compensation sections.

In a further embodiment of this aspect, a centre-to-centre distance between the input segment of the first waveguide and the first coupling section is similar to a centre-to-centre distance between the input segment of the fourth waveguide and the second phase compensation section, and whereby a centre-to-centre distance between the input segment of the second waveguide and the second coupling section is similar to a centre-to-centre distance between the input segment of the third waveguide and the first phase compensation section. In this aspect, the first, second, third and fourth waveguides may comprise single mode waveguides.

In another aspect, the present application discloses a method of forming a broadband photonic coupler comprising the steps of forming a directional coupler and a phase compensator. The formation of the direction coupler comprises forming a first waveguide having a first coupling section, an input section comprising an input segment and an input tapered segment that extends away from the input segment towards an end of the first coupling section, and an output section. A second waveguide of the directional coupler is formed to have a second coupling section, an input section comprising an input segment and an input tapered segment that extends away from the input segment towards an end of the second coupling section, and an output section. For the directional coupler, the first and second coupling sections are formed to have dissimilar widths, and whereby a coupling region of the directional coupler is defined by the first and second coupling sections. The formation of the phase compensator comprises forming a third waveguide comprising a first phase compensation section, an input section comprising an input segment and an input tapered segment that extends away from the input segment towards an end of the first phase compensation section, and an output section, whereby an end of the input segment of the third waveguide is connected to an end of the output section of the first waveguide. A fourth waveguide of the phase compensator is formed to have a second phase compensation section, an input section comprising an input segment and an input tapered segment that extends away from the input segment towards an end of the second phase compensation section, and an output section, whereby an end of the input segment of the fourth waveguide is connected to an end of the output section of the second waveguide. The input segments of the first, second, third and fourth waveguides are formed to have similar widths, a width of the first phase compensation section is formed to be similar to the width of the second coupling section, and a gap between the first and second coupling sections is formed to have a different gap spacing from a gap between the first and second phase compensation sections.

In a further embodiment of this another aspect, a center-to-center distance between the input segment of the first waveguide and the first coupling section is formed to be similar to a center-to-center distance between the input segment of the fourth waveguide and the second phase compensation section, and whereby a centre-to-centre distance between the input segment of the second waveguide and the second coupling section is formed to be similar to a centre-to-centre distance between the input segment of the third waveguide and the first phase compensation section.

In yet another aspect of the disclosure, the present application discloses a broadband photonic coupler comprising a directional coupler and a phase compensator. The directional coupler has a first waveguide having a first coupling section, an input section comprising an input segment and an input tapered segment that extends away from the input segment towards an end of the first coupling section, and an output section comprising an output segment and an output tapered segment that extends away from another end of the first coupling section towards the output segment. The directional coupler also has a second waveguide having a second coupling section, an input section comprising an input segment and an input tapered segment that extends away from the input segment towards an end of the second coupling section, and having an output section comprising an output segment and an output tapered segment that extends away from another end of the second coupling section towards the output segment, wherein the first and second coupling sections have dissimilar widths, and whereby a coupling region of the directional coupler is defined by the first and second coupling sections. The phase compensation section has a third waveguide having a first phase compensation section, an input section comprising an input segment and an input tapered segment that extends away from the input segment towards an end of the first phase compensation section, and an output section comprising an output segment and an output tapered segment that extends away from another end of the first phase compensation section towards the output segment, whereby an end of the input segment of the third waveguide is connected to an end of the output segment of the first waveguide. The phase compensation section also has a fourth waveguide having a second phase compensation section, an input section comprising an input segment and an input tapered segment that extends away from the input segment towards an end of the second phase compensation section, and an output section comprising an output segment and an output tapered segment that extends away from another end of the second phase compensation section towards the output segment, whereby an end of the input segment of the fourth waveguide is connected to an end of the output segment of the second waveguide, wherein the input and output segments of the first, second, third and fourth waveguides have similar widths. Furthermore, a width of the first phase compensation section is similar to the width of the second coupling section, and a width of a second phase compensation section is similar to the width of the first coupling section, and a gap between the first and second coupling sections has a different gap spacing from a gap between the first and second phase compensation sections.

### BRIEF DESCRIPTION OF THE DRAWINGS

Various embodiments of the present disclosure are described below with reference to the following drawings:

FIG. 1(a) illustrates a schematic representation of a broadband photonic coupler in accordance with an embodiment of the present disclosure;

FIG. 1(b) illustrates a schematic showing the labeled widths and lengths of the various parts of the broadband photonic coupler illustrated in FIG. 1(a);

FIG. 1(c) illustrates a schematic showing the labeled bend angles of the tapered segments and the labeled spacings between the waveguides of the broadband photonic coupler illustrated in FIG. 1(a);

FIG. 2 illustrates the variation in evanescent coupling between the two waveguides, when the gap spacing between the waveguides are varied for waveguides made from a 400 nm×220 nm silicon material a 400 nm×400 nm silicon nitride material;

FIG. 3(a) illustrates a coupling ratio of two waveguides as the coupling length of the two waveguides are varied;

FIG. 3(b) illustrates a coupling ratio of two waveguides as the wavelength of the propagating signal in the two waveguides are varied;

FIG. 3(c) illustrates a phase error for each target broadband coupling ratio of two waveguides;

FIG. 3(d) illustrates a coupling ratio of two waveguides as the wavelength of a propagating signal in the two waveguides are varied for a broadband photonic coupler designed in accordance with embodiments of the disclosure, a standard directional coupler, and a multimode interference coupler;

FIG. 4 illustrates a schematic representation of a coarse division wavelength multiplexing (CWDM) lattice filter which includes broadband photonic couplers designed in accordance with embodiments of the disclosure; and

FIG. 5 illustrates the simulated response of a coarse division wavelength multiplexing (CWDM) lattice filter which includes broadband photonic couplers designed in accordance with embodiments of the disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

In the context of various embodiments, the term “dissimilar” when used to compare features such as, but not limited to, the length, width, or size of two elements of the present disclosure means that the compared feature of the two elements is not alike or is different. When the features of two elements are dissimilar, this implies a lack of resemblance or a divergence in properties, appearance, nature, or other defining attributes.

In the context of various embodiments, the term “similar” when used to compare features such as, but not limited to, the length, width, or size of two elements of the present disclosure means that the compared features of the two elements are alike or has a resemblance to each other in some way. When the features of two elements are described as similar, it means that they share certain qualities or features that make them comparable or nearly the same.

In the context of various embodiments, the term “connected to” means two components or objects are physically and/or optically joined in such a way that allows light or signals to transfer efficiently between the two components. When this term is used in the context of a waveguide being connected to another waveguide, the implication is that guided modes or light signals are able to transfer from one waveguide to another with minimal loss, while maintaining the integrity of the signal.

In the context of various embodiments, the term “tapered waveguide” means an optical structure such as a waveguide, which has a width or cross-sectional area that changes gradually along a longitudinal axis of the waveguide, from one end to another end.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

A directional coupler comprises a device used in the field of photonics to split an input signal into two separate outputs or to combine two signals into one output. It functions by coupling a defined amount of the electromagnetic power in a waveguide to a port, thereby enabling the signal to be used in another circuit. In particular, the operation of a directional coupler is usually based on the evanescent coupling of signals between two waveguides placed in close proximity. As signals propagate through these waveguides, a portion of the energy from one waveguide is coupled into the other due to their near-field interactions whereby the amount of coupled power can be precisely controlled by adjusting the gap between the waveguides, their lengths, and the materials used.

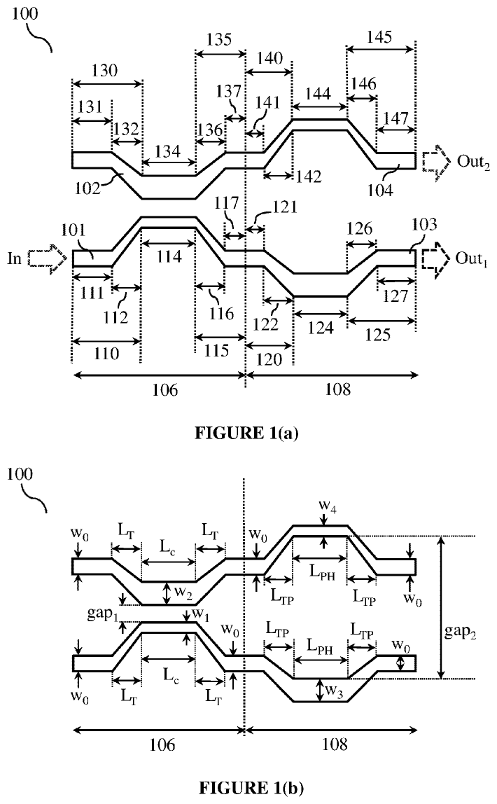

A schematic representation of a broadband photonic coupler in accordance with an embodiment of the present disclosure is illustrated in FIG. 1(a). In this embodiment, broadband photonic coupler comprises directional coupler 106 that is connected to phase compensator 108. In particular, the output ports of directional coupler 106 are connected to the input ports of phase compensator 108 such that when an input signal ‘In’ is provided to an input port of directional coupler 106, this input signal ‘In’ will be split into two separate output signals at the output ports of phase compensator 108, i.e., output signal ‘Out1’ and ‘Out2’.

In embodiments of the disclosure, directional coupler 106 comprises waveguide 101 and waveguide 102. Waveguide 101 comprises coupling section 114, input section 110 and output section 115. Input section 110 comprises two parts, which are input segment 111 and input tapered section 112 which extends away from an end of input segment 111 towards an end of coupling section 114 as shown in FIG. 1(a). Output section 115 also comprises two parts, which are output segment 117 and output tapered segment 116 that extends away from another end of coupling section 114 towards an end of output segment 117.

As for waveguide 102, this waveguide comprises coupling section 134, input section 130 and output section 135. Input section 130 comprises two parts, which are input segment 131 and input tapered section 132 which extends away from an end of input segment 131 towards an end of coupling section 134 as shown in FIG. 1(a). Output section 135 also comprises two parts, which are output segment 137 and output tapered segment 136 that extends away from another end of coupling section 134 towards an end of output segment 137. As illustrated in FIG. 1(a), a coupling region of directional coupler 106 is defined by the region where coupling sections 114 and 134 are brought into close proximity with each other, thereby allowing for the interaction and transfer of optical signals between waveguides 101 and 102.

In embodiments of the disclosure, phase compensator 108 comprises waveguide 103 and waveguide 104. Waveguide 103 is made up of phase compensation section 124, input section 120 comprising input segment 121 and input tapered segment 122 that extends away from an end of input segment 121 towards an end of phase compensation section 124, and output section 125 comprising output segment 127 and output tapered segment 126 that extends away from another end of phase compensation section 124 towards an end of output segment 127. As can be seen in FIG. 1(a), an end of input segment 121 is connected to an end of output section 115, i.e. output segment 117, such that a signal may propagate from waveguide 101 through to waveguide 103 thereby joining waveguide 101 to waveguide 103 together.

As for waveguide 104, this waveguide is made up of phase compensation section 144, input section 140 comprising input segment 141 and input tapered segment 142 that extends away from an end of input segment 141 towards an end of phase compensation section 144, and output section 145 comprising output segment 147 and output tapered segment 146 that extends away from another end of phase compensation section 144 towards an end of output segment 147. As illustrated in FIG. 1(a), an end of input segment 141 is connected to an end of output section 135, i.e., output segment 137, such that a signal may propagate from waveguide 102 through to waveguide 104 thereby joining waveguides 102 and 104 together.

In embodiments of the disclosure, the lengths of output segments 117 and 137 and input segments 121 and 141, along the longitudinal direction of these input and output segments, may be designed to very small, such that it may appear that output tapered segment 116 is connected to input tapered segment 122, and that output tapered segment 136 is connected to input tapered segment 142. Additionally, it should be noted that waveguides 101, 102, 103 and 104 may comprise single mode waveguides. Additionally, although tapered segments 112, 132, 116, 136, 122, 142, 126 and 146 are illustrated as linear/straight tapered waveguides, one skilled in the art will recognize that these tapered segments may comprise bent or curved waveguides such as, but are not limited to, S-shaped waveguides, C-shaped waveguides, U-shaped waveguides and etc. without departing from this disclosure.

It should be noted that the labels used in FIG. 1(a) may be used in FIGS. 1(b) and 1(c) as well as similar structures are shown in FIGS. 1(b) and 1(c). Reference is now made to FIG. 1(b) which illustrates the physical dimensions of waveguides 101 and 102 of directional coupler 106, and waveguides 103 and 104 of phase compensator 108. As illustrated in FIG. 1(b), the widths of coupling sections 114 and 134 are dissimilar, i.e. w₁≠w₂, while the widths of input and output segments 111, 131, 117, 137, 121, 141, 127, 147 correspondingly are all similar, i.e., all the widths are all w₀. Additionally, the width of coupling section 114 is similar as the width of phase compensation section 144, w₁=w₄, the width of coupling section 134 is similar as the width of phase compensation section 124, w₂=w₃, and a gap spacing gap₁ between coupling sections 114 and 134 is different from a gap spacing gap₂ between phase compensation sections 124 and 144, i.e. in this embodiment gap₂>gap₁.

As can be seen, input tapered segment 112 comprises a waveguide that tapers away from input segment 111 having width w₀ to coupling section 114 that has width w₁. A similar arrangement occurs at output section 115 where output tapered segment 116 comprises a waveguide that tapers away from output segment 117 having a width w₀ to coupling section 114 that has a width w₁.

With reference to waveguide 102, it can be observed that input tapered segment 132 features a waveguide that broadens from input segment 131, which has a width of w₀, to coupling section 134, which possesses a width of w₂. A corresponding design is implemented at output section 135, where output tapered segment 136 is a waveguide that broadens from output segment 137, with a width of w₀, to coupling section 134, which has a width of w₂.

Similarly for waveguide 103, it can be observed that input tapered segment 122 features a waveguide that broadens from input segment 121, which has a width of w₀, to phase compensation section 124, which possesses a width of w₃. A corresponding design is implemented at output section 125, where output tapered segment 126 is a waveguide that broadens from output segment 127, with a width of w₀, to phase compensation section 124, which has a width of w₃.

Further as illustrated, input tapered segment 142 comprises a waveguide that tapers away from input segment 141 having width w₀ to phase compensation section 144 that has width w₄. A similar arrangement occurs at output section 145 where output tapered segment 146 comprises a waveguide that tapers away from output segment 147 having a width w₀ to phase compensation section 144 that has a width w₄.

One skilled in the art will recognize that tapering directions of the tapered segments are dependent on the widths of the input segments and their corresponding connected coupling or phase compensation sections and is left as a design choice in accordance with embodiments of the disclosure.

Further, as can be seen in FIG. 1(b), coupling sections 114 and 134 have a coupling length of L_{C} and phase compensation sections 124 and 144 have a phase length of L_{PH}. In embodiments of the disclosure, the coupling length L_{C} is different from the phase compensation length L_{PH}, L_{C}≠L_{PH}. A phase compensation region defined by phase compensation sections 124 and 144 is used to compensate for phase errors that originate from directional coupler 106 and this may be achieved by adjusting the phase lengths L_{PH} of these phase compensation sections or by modifying the refractive index of waveguides 103 and 104. These adjustments allow the phase of the optical signal to be precisely controlled as it propagates through phase compensator 108

In further embodiments of the disclosure, the lengths L_{T} of all the tapered segments of directional coupler 106 are designed to be similar, i.e., tapered segments 112, 132, 116 and 136 each share identical lengths, as measured along the longitudinal direction of input segments 111, 131 or coupling sections 114, 134. Furthermore, the lengths L_{PH} of all the tapered segments of phase compensator 108 are made to be similar, i.e., tapered segments 122, 142, 126 and 146 each share identical lengths, as measured along the longitudinal direction of input segments 121, 141 or phase compensation sections 124, 144. In embodiments of the disclosure, the lengths L_{T} of the tapered segments of directional coupler 106 are different from the lengths LTP of the tapered segments of phase compensator 108.

It should be noted that widths w₁ and w₂ of coupling sections 114 and 134 respectively directly impacts the mode index mismatch A of directional coupler 106. The mode index mismatch A is defined as:

$$Δ = [ \frac{{η}_{eff} ( {w}_{2} )}{{η}_{eff} ( {w}_{1} )} ] - 1 \qquad equation ( 1 )$$

where η_{eff}(w) is the mode index of a particular waveguide having a width w. To balance the interplay between the spatial mode overlap and the coupling coefficient in directional coupler 106, it was determined that the mode index mismatch A may not be more than 5%. In embodiments of the disclosure, the value of the mode index mismatch A was determined by first simulating mode indices for waveguides of different widths. It was then determined from the simulation results that when the mode index mismatch A exceeded 25%, this resulted in poor tunability of the coupling ratio due to the overly large phase mismatch and overly small mode overlap. Hence, it can be said that the selection of the mode index mismatch A to be not more than 5% was a result of a tradeoff between the spatial mode overlap and the coupling coefficient between the waveguides. In embodiments of the disclosure, when waveguides 101, 102, 103, 104 comprise silicon nitride (SiN) with a thickness of 400 nm thickness, this translates to a requirement that the difference in the widths w₁ and w₂ of coupling sections 114 and 134 difference may not be more than 25%, i.e., w₂/w₁<1.25.

It should also be noted that the labels used in FIG. 1(b) may also be used in FIG. 1(c) as well. Reference is now made to FIG. 1(c) which illustrates some additional physical parameters of broadband photonic coupler 100. Input segments 111 and 131 have a center-to-center distance of Δy, which is defined as Δy=2·yₚₒᵣₜ where input port vertical offset yₚₒᵣₜ is the center-to-center distance between a central axis of input segments 111, 131 and a central axis of the coupling region defined by coupling sections 114, 134 as illustrated in FIG. 1(c).

In embodiments of the disclosure, the lengths L_{T} of all the tapered segments of directional coupler 106 are designed such that a bend angle θ_{S1} of the input and output tapered segments are kept small, whereby the bend angles of these tapered segments are defined as an acute angle between a longitudinal axis of input segment 111 and a longitudinal axis of input tapered segment 112. This is done to avoid a mode conversion loss in the coupling, i.e., to avoid the slow varying envelope variation. As a result, it was determined that the bend angle of tapered segments is to be kept small, i.e., may not be more than 15°, i.e., θ_{S1}<15°. In embodiments of the disclosure, the angle θ_{S1} is kept small so that the mode is able to propagate in a ‘paraxial approximation’ in this waveguide (sin θ≈θ). As for phase compensator 108, the lengths L_{TP} of all the tapered segments are designed such that a bend angle θ_{S2} of the input and output tapered segments are not more than 25°, i.e., θ_{S2}<25°, whereby the bend angles of these tapered segments are defined as an acute angle between a longitudinal axis of input segment 141 and a longitudinal axis of input tapered segment 142. Similarly, the angle θ_{S2} is kept small so that the mode is able to propagate in a ‘paraxial approximation’ in this waveguide (sinθ≈θ). The requirement placed on the bend angle θ_{S2} of the input and output tapered segments of phase compensator 108 are more relaxed that the bend angle θ_{S1} requirement for directional coupler 106 as evanescent coupling does not occur at the phase compensation region of coupler 108. Furthermore, the bend angles were set to be θ_{S2}>θ_{S1} so that the waveguides will not be bent at angles that are too sharp. This in turn reduces the amount of coupling loss that may occur in directional coupler 106.

In embodiments of the disclosure, vertical offsets y_{C1} of input and output segments 111 and 117 respectively are designed to be similar as vertical offsets y_{C4} of input and output segments 141 and 147 respectively. Vertical offset y_{C1} may be defined as a center-to-center distance between a central axis of input segment 111/a central axis of output segment 117 and a central axis of coupling section 114 while vertical offset y_{C4} may be defined as a center-to-center distance between a central axis of input segment 141/a central axis of output segment 147 and a central axis of phase compensation section 144.

In embodiments of the disclosure, vertical offsets y_{C2} of input and output segments 131 and 137 are designed to be similar as vertical offsets y_{C3} of input and output segments 121 and 127. As for vertical offset y_{C2}, this vertical offset may be defined as a center-to-center distance between a central axis of input segment 131/a central axis of output segment 137 and a central axis of coupling section 134 while vertical offset y_{C3} may be defined as a center-to-center distance between a central axis of input segment 121/a central axis of output segment 127 and a central axis of phase compensation section 124.

It should be noted that a center-to-center spacing between output segments 127 and 147 is similar as the center-to-center distance of Δy of input segments 111 and 131, which is defined as Δy=2·yₚₒᵣₜ where input port vertical offset yₚₒᵣₜ is the center-to-center distance between a central axis of input segments 111, 131 and a central axis of the coupling region defined by coupling sections 114, 134 as illustrated in FIG. 1(c).

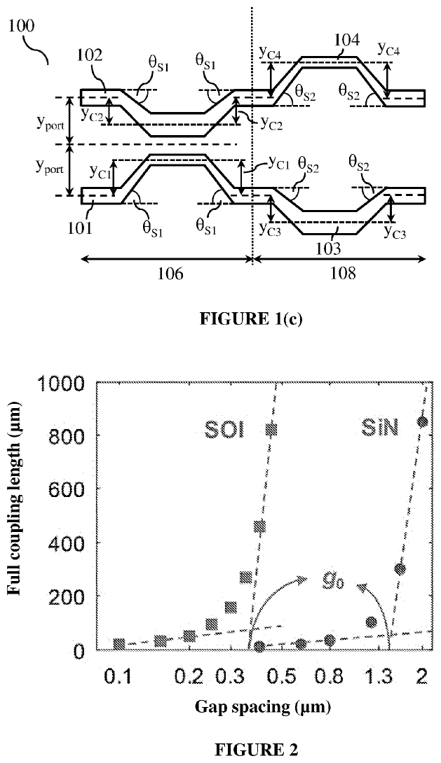

In embodiments of the disclosure, depending on the materials used for broadband photonic coupler 100, a situation may exist where the bend angle θ_{S2} of the input and output tapered segments of phase compensator 108 may not be necessary, i.e. θ_{S2}=0° and as a result, y_{C2}≠y_{C3}, y_{C1}≠y_{C4}. The requirement for this situation is formulated as 2·yₚₒᵣₜ−gap₁−w₀>g₀, where go represents the widest gap spacing that still allows for evanescent wave coupling to occur between coupling sections 114 and 134. This maximum gap spacing, go, is strongly dependent on the refractive index contrast of the material system using for broadband photonic coupler 100 and the physical dimensions of the waveguides. The relationship between the maximum gap spacing, go and the refractive index contrast of the material system is illustrated in FIG. 2 which shows a marked exponential relationship to the coupling length for both Silicon-on-Insulator (SOI) and Silicon Nitride (SiN) material systems. By analyzing the point where the gap begins to affect the coupling length's slope—identified through the intersection of two asymptotes—go values of 340 nm were obtained for a SOI material system and 1.4 μm for a SiN material system.

### Simulation Results

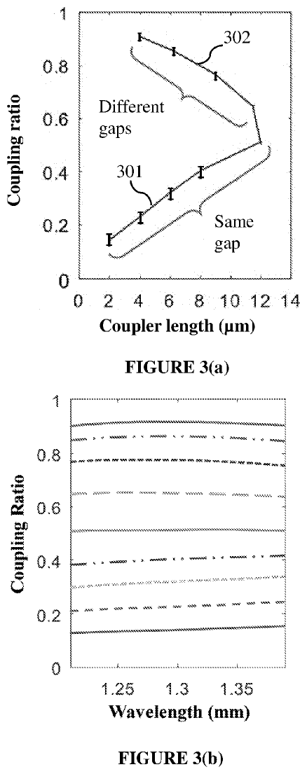

In this simulation, the broadband photonic coupler was formed using a SiN material system whereby the waveguides comprise 400 nm thick SiN formed on a silicon substrate and clad with silicon dioxide (SiO₂). One skilled in the art will recognize that other material systems such as, but are not limited to, silicon-on-insulator material systems, polymer material systems or III-V material systems (i.e., semiconductor compounds composed of elements from Group III and Group V of the periodic table such as gallium (Ga), indium (In), and aluminum (Al) from Group III, and arsenic (As), phosphorus (P), and nitrogen (N) from Group V) may also be used without departing from this disclosure. The intended operating wavelength range of the broadband photonic coupler was in the O-band, whereby the wavelengths range from A=1.25 μm to 1=1.35 μm, specifically for the known O-band wavelength channels at 1271 nm, 1291 nm, 1311 nm, and 1331 nm. In terms of dispersive properties, the SiN material system was selected as SiN exhibits much less dispersion as compared to a silicon material system, while still having a refractive index high enough to enable high device integration. The other reason for choosing a SiN material system for the broadband photonic coupler is that SiN has larger critical dimensions as compared to silicon-based systems, making a SiN-based system more tolerant to fabrication imperfections. The simulation results illustrated in FIG. 3 are based on an Eigen Mode Expansion method (EME) with Transverse-Electric (TE) guided mode as the input.

In general, once the width w₀ of the input and output segments of the broadband photonic coupler was determined, the widths w₁, w₂ of the coupling sections of the directional coupler are then determined based on the mode mismatch needed for a certain broadband coupling ratio through the use of Equation (1). In this example, the widths w₀ of the input and output segments of the broadband photonic coupler were chosen to be w₀=400 nm, while the widths of the waveguide in the coupling region, i.e., coupling sections, are set as w₁=400 nm and w₂=450 nm. One skilled in the art will recognize that the width w₀ is not restricted to 400 nm, and that this value of w₀ was chosen as an illustration of a square-shaped SiN waveguide with 400 nm×400 nm cross sections, which was previously found to be polarization insensitive. The input port vertical offset (yₚₒᵣₜ) was set to be 1 μm, while the gap spacing, gap₁ between the coupling sections of the direction coupler was varied between 250 nm and 650 nm.

FIG. 3(a) illustrates the mapping of achievable coupling ratios (K) as a function of coupler lengths, which ranges from K=10.11±0.77% to K=91.38±0.76%. In this plot, the vertical error bars illustrate the uniformity of the coupling ratio spectrum over a wavelength range of 200 nm (1.2 μm<λ<1.4 μm), as presented in FIG. 3(b). When a fixed gap spacing of 650 nm was used, it was found from FIG. 3(a) that coupling ratios ranging from K=10.11±0.77% to K=49.67±0.68% are readily obtained when the lengths of the coupling sections were varied from L_{C}=2 μm to L_{C}=12 μm, as shown in plot 301. To keep the footprint of the broadband photonic coupler small, it should be noted that a larger coupling ratio (K>50%) may be obtained by varying both the gap spacing and coupling length as needed. This is illustrated in plot 302 of FIG. 3(a) which shows an increase of the coupling ratio from K=49.67±0.68% to K=91.38±0.76% when the gap spacing is decreased from 650 nm to 250 nm, whereby length of the coupling sections decreases accordingly with the gap spacing from L_{C}=12 μm to L_{C}=4.5 μm.

The phase responses for these broadband coupling ratios are illustrated in FIG. 3(c), which shows the uniformity in phase when the average coupling ratio is at the 200 nm wavelength range. The phase length for each coupling ratio was adjusted accordingly such that the average phase is at the ideal value, i.e., φ=π/2. The horizontal error bars signify the non-uniformity of the phase across the O-band spectrum when the wavelength of the signal is between 1.25 μm<λ<1.35 μm, with ±10% and ±20% phase errors as indicated by the shaded band 304 and dashed lines 305, respectively. FIG. 3(c) also shows that broadband coupling ratios can be achieved with smaller than 10% phase errors for coupling ratios up to 50%. It was also found that the phase error is about 20% for coupling ratios close to 92%, which is expected due to its proximity to phase matched conditions (where 100% coupling occurs). The sets of geometrical parameters for these coupling ratios are summarized in Table. 1 below, which are simulated based on coupling sections having the following widths: w₁=400 nm and w₂=450 nm, h=400 nm and SiO₂ cladding. In terms of device footprint, it was found that this full range of broadband phase-corrected coupling is realizable with device lengths being not more than 40 μm.

TABLE 1

| K (%) | Φ (in π) | Gap (nm) | L_{T} (μm) | L_{C} (μm) | L_{TP} (μm) | L_{PH} (μm) |
|---|---|---|---|---|---|---|
| 10.11 ± 0.77 | 0.5 ± 0.02 | 650 | 4 | 2 | 1 | 1.5 |
| 18.46 ± 1.33 | 0.51 ± 0.02 | 650 | 4 | 4 | 2 | 1.6 |
| 27.80 ± 1.66 | 0.50 ± 0.03 | 650 | 4 | 6 | 3 | 2 |
| 36.69 ± 1.64 | 0.5 ± 0.04 | 650 | 4 | 8 | 3 | 3.6 |
| 44.22 ± 1.36 | 0.5 ± 0.06 | 650 | 4 | 10 | 3 | 5.2 |
| 49.67 ± 0.68 | 0.5 ± 0.07 | 650 | 4 | 12 | 3 | 7.2 |
| 66.11 ± 1.06 | 0.5 ± 0.11 | 550 | 4 | 12 | 3 | 9.6 |
| 77.62 ± 0.96 | 0.5 ± 0.13 | 450 | 4 | 9 | 3 | 10 |
| 85.80 ± 0.89 | 0.5 ± 0.14 | 350 | 4 | 6.5 | 3 | 8.5 |
| 91.38 ± 0.76 | 0.5 ± 0.14 | 250 | 4 | 4.5 | 3 | 8 |

FIG. 3(d) illustrates the coupling ratio of the broadband photonic coupler designed in accordance with the disclosure, a multimode interferometer (MMI) and a standard direction coupler (DC) when the wavelength of the received optical signal is varied. As illustrated in this figure, it can be seen that the broadband photonic coupler was able to achieve a much flatter spectral response 311 as compared to the spectral responses of those generated by the plot 312 for MMI 312 and the plot 313 for DC.

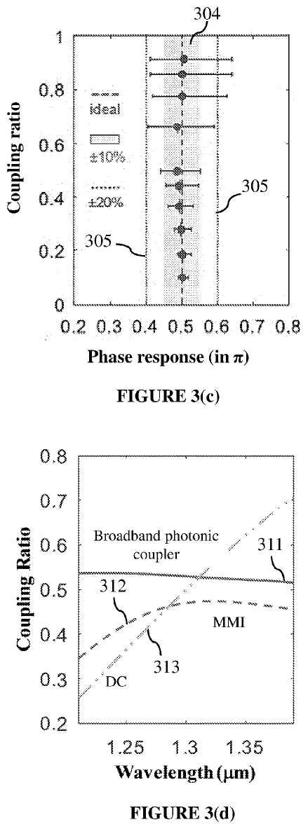

The role of phase correction is illustrated with its incorporation into a 4-channel CWDM multiplexer (MUX) design, and this is illustrated in FIG. 4. The 4-channel CWDM MUX is based on a lattice filter architecture, formed by multiple stages of Mach Zehnder Interferometers, each with specific combinations of coupling ratios and phase shifts. The broadband photonic coupler 402 designed in accordance with embodiments of the disclosure and the standard optical coupler 404 are represented by the rectangle boxes, while the phase shift sections 406 are represented by the square boxes. An advantage of the broadband photonic coupler is demonstrated in the performance of the 4-channel CWDM MUX which incorporates the broadband photonic coupler described in this disclosure.

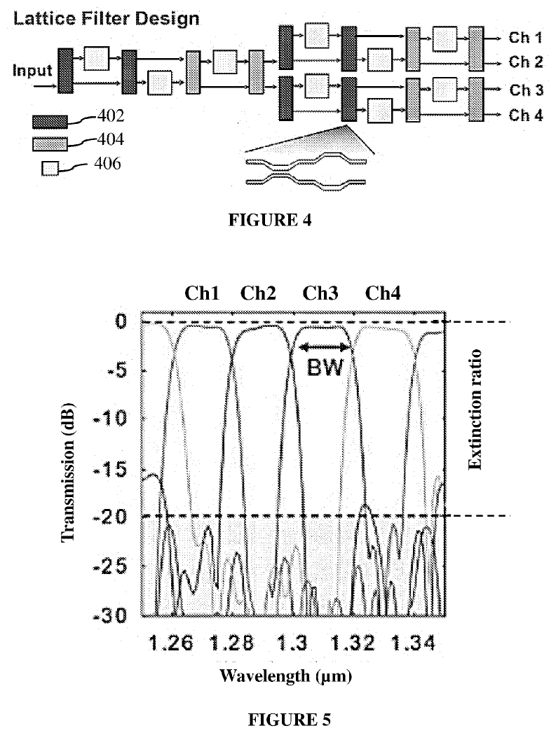

The MUX performances of the broadband photonic coupler are illustrated in FIG. 5 based on the specifications inspired from realistic industrial demand, such as an extinction ratio (ER) of ER≥20 dB, Insertion Loss (IL) of IL≤2 dB, and channel bandwidth (BW) of BW=12 nm. From FIG. 5, a flat spectrum can be observed across the wavelength channels within the O-band, with ER≥20 dB and IL≤2 dB.

Numerous other changes, substitutions, variations, and modifications may be ascertained by the skilled in the art and it is intended that the present application encompass all such changes, substitutions, variations, and modifications as falling within the scope of the appended claims.

1. A broadband photonic coupler comprising:
a directional coupler comprising:
a first waveguide having a first coupling section, an input section comprising an input segment and an input tapered segment that extends away from the input segment towards an end of the first coupling section, and an output section;
a second waveguide having a second coupling section, an input section comprising an input segment and an input tapered segment that extends away from the input segment towards an end of the second coupling section, and having an output section,
wherein the first and second coupling sections have dissimilar widths, and whereby a coupling region of the directional coupler is defined by the first and second coupling sections,
a phase compensator comprising:
a third waveguide having a first phase compensation section, an input section comprising an input segment and an input tapered segment that extends 16 away from the input segment towards an end of the first phase compensation section, and an output section, whereby an end of the input segment of the third waveguide is connected to an end of the output section of the first waveguide,
a fourth waveguide having a second phase compensation section, an input section comprising an input segment and an input tapered segment that extends away from the input segment towards an end of the second phase compensation section, and an output section, whereby an end of the input segment of the fourth waveguide is connected to an end of the output section of the second waveguide,
wherein the input segments of the first, second, third and fourth waveguides have similar widths,
wherein a width of the first phase compensation section is similar to the width of the second coupling section, and a width of a second phase compensation section is similar to the width of the first coupling section, and
wherein a gap between the first and second coupling sections has a different gap spacing from a gap between the first and second phase compensation sections.

2. The broadband photonic coupler according to claim 1 whereby a center-to-center distance between the input segment of the first waveguide and the first coupling section is similar to a center-to-center distance between the input segment of the fourth waveguide and the second phase compensation section, and whereby a center-to-center distance between the input segment of the second waveguide and the second coupling section is similar to a center-to-center distance between the input segment of the third waveguide and the first phase compensation section.

3. The broadband photonic coupler according to claim 1 wherein the first, second, third and fourth waveguides comprise single mode waveguides.

4. The broadband photonic coupler according to claim 1, whereby the widths of the first and the second coupling sections differ by 25% or less when the first, second, third and fourth waveguides comprise silicon nitride.

5. The broadband photonic coupler according to claim 1, whereby the input tapered segment of the first waveguide has a similar length as the input tapered segment of the second waveguide when measured along a longitudinal direction of the first and second coupling sections.

6. The broadband photonic coupler according to claim 5, whereby a bend angle of the input tapered segment of the first waveguide is 15° or less, wherein the bend angle of the input tapered segment of the first waveguide is defined as an acute angle between the longitudinal axis of the input segment of the first waveguide and a longitudinal axis of the input tapered segment of the first waveguide.

7. The broadband photonic coupler according to claim 1, whereby the input tapered segment of the third waveguide has a similar length as the input tapered segment of the fourth waveguide when measured along a longitudinal direction of the first and second phase compensation sections.

8. The broadband photonic coupler according to claim 7, whereby a bend angle of the input tapered segment of the third waveguide is 25° or less, wherein the bend angle of the input tapered segment of the third waveguide is defined as an acute angle between the longitudinal axis of the input segment of the third waveguide and a longitudinal axis of the input tapered segment of the third waveguide.

9. The broadband photonic coupler according to claim 1, wherein the first, second, third and fourth waveguides 2 comprise silicon nitride-on-silicon material systems, silicon-on-insulator material systems or III-V material systems.

10. The broadband photonic coupler according to claim 1, wherein the gap between the first and second coupling sections is between 250 nm and 650 nm when the first, second, third and fourth waveguides comprise silicon nitride with 400 nm×400 nm cross sections.

11. A method for forming a broadband photonic coupler comprising:
forming a directional coupler comprising the steps of:
forming a first waveguide having a first coupling section, an input section comprising an input segment and an input tapered segment that extends away from the input segment towards an end of the first coupling section, and an output section;
forming a second waveguide having a second coupling section, an input section comprising an input segment and an input tapered segment that extends away from the input segment towards an end of the second coupling section, and having an output section,
wherein the first and second coupling sections are formed to have dissimilar widths, and whereby a coupling region of the directional coupler is defined by the first and second coupling sections,
forming a phase compensator comprising the steps of:
forming a third waveguide comprising a first phase compensation section, an input section comprising an input segment and an input tapered segment that extends away from the input segment towards an end of the first phase compensation section, and an output section, whereby an end of the input segment of the third waveguide is connected to an end of the output section of the first waveguide,
forming a fourth waveguide comprising a second phase compensation section, an input section comprising an input segment and an input tapered segment that extends away from the input segment towards an end of the second phase compensation section, and an output section, whereby an end of the input segment of the fourth waveguide is connected to an end of the output section of the second waveguide,
wherein the input and output segments of the first, second, third and fourth waveguides are formed to have similar widths, wherein a width of the first phase compensation section is formed to be similar to the width of the second coupling section, and a width of a second phase compensation section is formed to be similar to the width of the first coupling section, and
wherein a gap between the first and second coupling sections is formed to have a different gap spacing from a gap between the first and second phase compensation sections.

12. The method according to claim 11 whereby a center-to-center distance between the input segment of the first waveguide and the first coupling section is formed to be similar to a center-to-center distance between the input segment of the fourth waveguide and the second phase compensation section, and whereby a center-to-center distance between the input segment of the second waveguide and the second coupling section is formed to be similar to a center-to-center distance between the input segment of the third waveguide and the first phase compensation section.

13. The method according to claim 11 wherein the first, second, third and fourth waveguides comprise single mode waveguides.

14. The method according to claim 11, whereby the widths of the first and the second coupling sections are formed to differ by 25% or less when the first, second, third and fourth waveguides are formed from silicon nitride.

15. The method according to claim 11, whereby the input tapered segment of the first waveguide is formed to have a similar length as the input tapered segment of the second waveguide when measured along a longitudinal direction of the first and second coupling sections.

16. The method according to claim 15, whereby a bend angle of the input tapered segment of the first waveguide is formed to be 15° or less, wherein the bend angle of the input tapered segment of the first waveguide is defined as an acute angle between the longitudinal axis of the input segment of the first waveguide and a longitudinal axis of the input tapered segment of the first waveguide.

17. The method according to claim 11, whereby the input tapered segment of the third waveguide is formed to have a similar length as the input tapered segment of the fourth waveguide when measured along a longitudinal direction of the first and second phase compensation sections.

18. The method according to claim 17, whereby a bend angle of the input tapered segment of the third waveguide is formed to be 25° or less, wherein the bend angle of the input tapered segment of the third waveguide is defined as an acute angle between the longitudinal axis of the input segment of the third waveguide and a longitudinal axis of the input tapered segment of the third waveguide.

19. The method according to claim 11, wherein the first, second, third and fourth waveguides are formed from silicon nitride-on-silicon material systems, silicon-on-insulator material systems or III-V material systems.

20. The method according to claim 11, wherein a gap between the first and second coupling sections is formed with a width between 250 nm and 650 nm when the first, second, third and fourth waveguides comprise silicon nitride with 400 nm×400 nm cross sections.
